(19) United States
(12) Patent Application Publication
(10) Pub. No.: US 2012/0212320 A1
(43) Pub. Date: Aug. 23, 2012

(54) Motor vehicle light synchronization system

(76) Inventor: Steven L. Oberholtzer, Chelsea, MI (US)

(21) Appl. No.: 12/932,148

(22) Filed: Feb. 18, 2011

(51) Int. Cl. G05B 23/02

(52) U.S. Cl. 340/3.2

(57) ABSTRACT

A synchronization system for motor vehicles which enable external blinking or flashing lights of one or a number of vehicles to be synchronized. Among a group of motor vehicle, such as those produced by a given motor vehicle manufacturer, when the operators of the vehicles activate the turn signals or emergency flashers, they blink in unison with one another. External timing signals are used to establish the phasing of the flashing or blinking oscillations.

### FIELD OF INVENTION

This invention relates to motor vehicles, and particularly to a system for synchronizing functions of one or a number of motor vehicles.

### BACKGROUND AND SUMMARY OF THE INVENTION

Certain external signal lights of motor vehicles, such as blinking turn signals. and emergency flashers, are timed to go from their low to their high illumination states using a timer within the motor vehicle. Because this timer is not coupled externally outside the vehicle, it is not synchronized with other motor vehicles or with any remote signal. This invention is a system for enabling a number of motor vehicles to have synchronized functions, such as external blinking signal lights or emergency flashers. By using an external timing signal, such as obtained by a global positioning system satellite or cellular phone system antenna, a number of vehicles can have synchronized blinking light signals. Thus when turn signals or emergency flashers are activated, a number of vehicles could be caused to have their flashing external lights synchronized together. The synchronization could be consistent within certain motor vehicle groups, such as those manufactured by a particular OEM vehicle manufacturer. For example, drivers of certain types of motor vehicles, such as sports car or luxury models made by a certain manufacturer, can be controlled to have synchronizing blinking turn signal and emergency flasher functions. Thus, when a number of vehicles are preparing to make a turn and are stopped at an intersection, or awaiting traffic, these synchronized vehicles would have turn signals or emergency flashers flashing on and off together. This would provide a sense of community among drivers of such similar vehicles. The drivers may also indentify this feature as an indication of precision and that the vehicle incorporates high technology, leading edge functions, advantageous for marketing the vehicle. In addition to providing a potentially desirable feature for motor vehicle owners, such synchronization could also provide other benefits. For example, police, fire, or other emergency crews could have such synchronizations so they would be better able to identify one another, which may be especially useful in covert operations. Using the invention, vehicles in parades or other demonstrations could also be synchronized for dramatic effects.

Additional benefits and advantages of the present invention will become apparent to those skilled in the art to which the present invention relates from the subsequent description and preferred embodiment of the append claims, taken in conjunction with the accompanying drawings.

### BRIEF DESCRIPTION OF THE DRAWINGS

FIG. 1 is a pictorial view showing two motor vehicle having a synchronization system in accordance with this invention;

FIG. 2 is a schematic diagram of the system in accordance with this invention as incorporated into a motor vehicle

FIG. 3 is a graph showing the synchronization of light functions between two motor vehicles; and

FIG. 4 is a graph showing the synchronization of light functions between two motor vehicles baying offset synchronization.

### DETAILED DESCRIPTION OF THE INVENTION

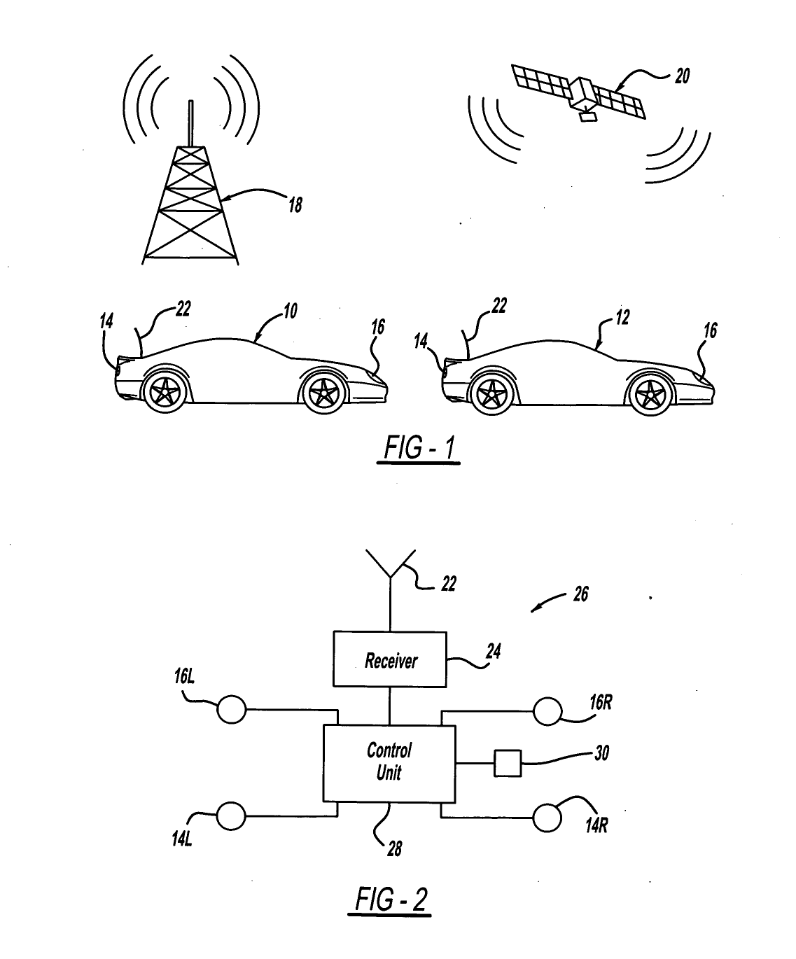

In FIG. 1, two motor vehicles are shown designated by reference numbers 10 and 12 which may be operated on a roadway in close proximity with one another or some distance apart. Motor vehicles 10 and 12 incorporate rear signal lamps 14 and front signal lamps 16. Signal lamps 14 and 16 are associated with a turn signal function for the motor vehicles 10 and 12, and may also operate as emergency flashers. Thus, the signal lamps 14 and 16 exhibit high and low illumination states in accordance with motor vehicle certification requirements, operate in a blinking or flashing manner to provide indications for other drivers. In some cases, the lamps 14 and 16, when operating in a blinking or flashing manner, turn off and on, in other cases, the lamps are formed from a number of discrete lamps, such as LEDs in which one group stays illuminated while another group is turned on and off. To refer to both types, “blinking” or “flashing” in this description refers to going between high and low illumination states.

In accordance with the present invention, motor vehicle 10 and 12 both receive signals from some external source, such as a cell phone tower 18 which radiates radio frequency signals as part of a cellular phone network. These signals include a timing or clock function. Alternatively, or in addition to cell phone tower 18, global positioning system (GPS) satellite 20 similarly generates signals for ground based systems which is part of a constellation of similar satellites used to provide GPS position indications for vehicles, handheld units cell phones, and other devices on earth. Like cell phone tower 18, signals from GPS satellite 20 includes timing signals or information. GPS signal timing elements are highly accurate and are part of the fundamental operational functions of the GPS system. Other satellite signals could be used such as those part of satellite radio networks.

Motor vehicles 10 and 12 both include receiving antenna 22 and onboard receiver 24 which receive the externally produced signals captured by antenna 22 which are used for multiple functions, including, in accordance with the present invention, the control of signal lamps 14 and 16.

FIG. 2 illustrates diagrammatically the system 26 in accordance with this invention. The elements shown in FIG. 2 are present in each of motor vehicles 10 and 12, and any number of additional vehicles for which the synchronization function is desired. As shown, receiving antenna 22 is connected with receiver 24 which outputs timing signals sent to control unit 28. Control unit 28 in turn controls the illumination of front turn signals 16, divided into left and right hand front turn signals 16L and 16R respectively, and rear turn signals, divided into left and right hand rear lamps 14L and 14R, respectively.

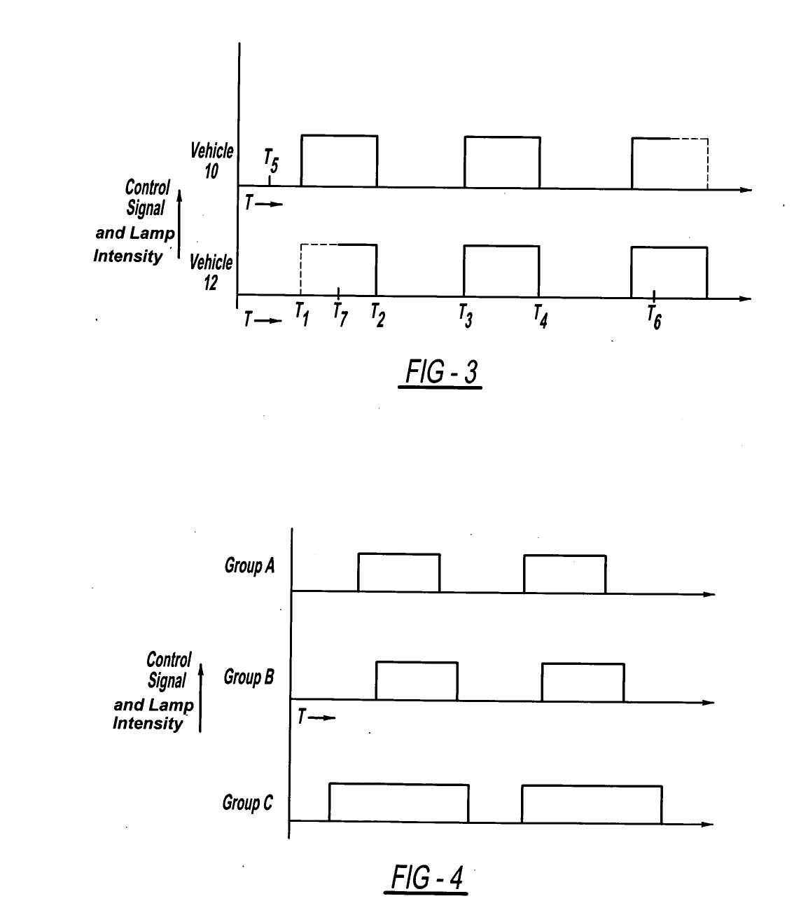

With reference to FIG. 3, the operation of the illumination of front and rear signal lamps 14 and 16 is described. The graph of FIG. 3 shows the illumination of the lamps with respect to time for vehicles 10 and 12 when the flashing or blinking function is activated. In the graphs, square wave forms are shown which correspond with either a control signal alone or the illumination level of the lamp being controlled. A control signal alone is indicated by dotted lines for the control of the lamp illumination, which is defined by control system 26. The lines of the square wave are shown in full lines when the signal lamp is illuminated at the high level. In the graphs of FIGS. 3 and 4, the vertical axes represents indicate the presence of the illumination intensity control signal, and when the signal light is illuminated, the axes indicate the electrical current applied to the signal lights (or their illumination intensity). The graph shows an oscillation pattern in a square wave form, going to a high level to a low level in a cyclical manner. Any number of additional motor vehicles could also have the synchronization pattern illustrated in FIG. 3. As shown over time, the control signal is low until reaching T₁, and stays high until T₂, goes low in a dwell period to T₃ and high again until T₄ When the lamps are illuminated the lamps are illuminated in accordance with the square wave form This process continues for as long as the turn signal or blinking lamp functions of the vehicles are activated.

Preferably, control unit 28 receives the external timing signals and provides a running stream of commands, such as the pulse string shown in FIG. 3, irrespective of activation of the flashing or blinking function. When the vehicle operator activates the turn signal or emergency flashing function, they are operated in accordance with the timing schedule shown in FIG. 3. For example, vehicle 10 may have the turn signal activated at T₅. This corresponds to a period of the low illumination state and thus the signal would not be activated until reaching T₁ where the signal is illuminated as indicated by the full lines in FIG. 3. If the operator deactivates the signal at T₆ the illumination returns to the low level. Vehicle 12 may have its turn signal activated at time T₇, which is during a phase of illumination at the high level. The pulse string in the lower portion of FIG. 3 is dotted until the light is illuminated at T₆. Thus the initiation of activation of the turn signals of vehicles 10 and 12 is done at a time independent of other vehicles, but very quickly both vehicles become exactly synchronized with the signal lamps going from the high to the low states at the same time.

FIG. 4 shows that the synchronization can occur within groups in a manner which differ from one another. For example, one vehicle manufacturer could choose a certain distinct synchronization pattern and another could use one that differs. As shown in FIG. 4, Group A shows one synchronization pattern, whereas Group B has the same periods of high and low illumination levels, but the square wave pattern has a phase difference from group A. Group C has a longer high illumination level period as compared to Groups A or B. In this manner, a number of vehicles could be synchronized in accordance with Group A, another group of vehicles synchronized in accordance with Group B, and finally, yet another synchronized in accordance with Group C. Many different illumination patterns could be selected, with multiple vehicles sharing a pattern which may differ from other groups.

In certain conditions, it may be unreliable to control the flashing or blinking light functions of a motor vehicle strictly using external signals. It may be determined that it would not be acceptable for the important blinking or flashing functions to be dependant solely on external signals. The vehicle could use an internal blinking timer 30, shown in FIG. 2 having a set blinking period where the phasing of the flashing is set periodically to the external signal. Thus synchronization phasing occurs periodically, whereas the cyclical flashing is timed using internal timer 30.

The invention may also be implemented in its simplest form by a single vehicle having its blinking or flashing light function having its pulsing pattern controlled or based on an external signal timing que.

In addition to being useful as a means of providing a sense of identity among operators of similar vehicles, the system in accordance with this invention might be used in police or military work where it may be useful for a group of vehicles to be able to determine if separated vehicles are part of a group. With non-synchronized vehicles, as in accordance with the prior art, synchronization of turn signals may appear to be occurring, although they are operated autonomously, but after a period of simultaneous operation, a lack of synchronization becomes apparent.

While the above description constitutes the preferred embodiment of the present invention, it will be appreciated that the invention is susceptible to modification, variation and change without departing from the proper scope and fair meaning of the accompanying claims.

1. A system for synchronizing a flashing or blinking signal light function of a motor vehicle, comprising:
a receiver in the motor vehicle for receiving external timing signals and outputting a control signal, and
a control unit in the, vehicle for receiving the control signal and controlling the phasing of the signal light function of the motor vehicle.

2. A system in accordance with claim 1 wherein the signal light functions of a plurality of motor vehicles are based on the external timing signals such the plurality of vehicles exhibit synchronization of their signal light functions.

3. A system in accordance with claim 1 wherein the signal light function is turn signals of the motor vehicle.

4. A system in accordance with claim 1 wherein the signal light function is emergency flashers of the motor vehicle.

5. A system in accordance with claim 1 wherein the external timing signal is a radio frequency signal received by an antenna of the vehicle from one or more global positioning system satellites.

6. A system in accordance with claim 1 wherein the external timing signal is a radio frequency signal received by an antenna of the vehicle from a cellular telephone antenna.

7. A system in accordance with claim 1 wherein the external timing signal is a radio frequency signal received by an antenna of the vehicle from a satellite radio satellite.

8. A system in accordance with claim 1 wherein the signal light function is one or more external lights which flash from a high illumination level to a low illumination level.

9. A system in accordance with claim 7 wherein the synchronization comprises causing the signal light function of the plurality of external light to move to the high and the low illumination levels at the same time.

10. A system in accordance with claim 1 wherein the plurality of motor vehicles includes at least two groups having synchronization patterns which differ one another.

11. A system in accordance with claim 1 wherein the control unit of a first vehicle generates a first oscillation pattern which is synchronized with a second oscillation pattern of a second vehicle and the light signal functions of the first and second vehicles are controlled in response the oscillation patterns when the operator of the vehicles activate the external light function.

12. A system in accordance with claim 1 wherein the control unit includes an internal timer which generates a cyclical illumination control signal and the external control signal is used to establish the phasing of the illumination pattern.

13. A system for synchronizing signal light functions of a plurality of motor vehicles in the form of external lights which flash or blink from a high illumination level to a low illumination level, comprising:
a receiver in a motor vehicle for receiving external timing signals and outputting a control signal, and
a control unit on the vehicle for receiving the control signal and controlling a signal light function of the motor vehicle such that the plurality of vehicles exhibit synchronization of their signal light functions such that the external lights of the plurality of the vehicles move to the high and the low illumination states at the same time.

14. A system in accordance with claim 13 wherein the signal light function is turn signals of the motor vehicle.

15. A system in accordance with claim 13 wherein the signal light function is emergency flashers of the motor vehicle.

16. A system in accordance with claim 13 wherein the external timing signal is a radio frequency signal received by an antenna of the vehicle from one or more global positioning system satellites.

17. A system in accordance with claim 13 wherein the external timing signal is a radio frequency signal received by an antenna of the vehicle from a cellular telephone antenna.

18. A system in accordance with claim 13 wherein the external timing signal is a radio frequency signal received by an antenna of the vehicle from a satellite radio satellite.

19. A system in accordance with claim 13 wherein the synchronization comprises causing the signal light function of the plurality of external light to move to the high and the low illumination levels at the same time.

20. A system in accordance with claim 13 wherein the plurality of motor vehicles includes at least two groups having synchronization patterns which differ one another.

21. A system in accordance with claim 13 wherein the control unit of a first vehicle generates a first oscillation pattern which is synchronized with a second oscillation pattern of a second vehicle and the light signal functions of the first and second vehicles are controlled in response the oscillation patterns when the operator of the vehicles activate the external light function.

22. A system in accordance with claim 13 wherein the control unit includes an internal timer which generates a cyclical illumination control signal and the external control signal is used to establish the phasing of the illumination pattern.
